(19) United States
(12) Patent Application Publication
(10) Pub. No.: US 2005/0151725 A1
(43) Pub. Date: Jul. 14, 2005

(54) User interface device

(76) Inventor: Christopher Parks Jennings, Brooklyn, NY (US)

Correspondence Address: Vincent E. Duffy, 13502 Flintridge Pass, Carmel, IN, 46033, US

(21) Appl. No.: 11/027,107

(22) Filed: Dec. 30, 2004

Related U.S. Application Data
(60) Provisional application No. 60/533,299, filed on Dec. 30, 2003.

(51) Int. Cl. G09G 5/08; G09G 5/00

(52) U.S. Cl. 345/167; 345/157; 345/168; 345/169; 345/184

(57) ABSTRACT

A user interface device that places a trackball and input buttons in relative proximity to both the hand and computer keyboard via a strap or physical support that precludes the need to move the hand back and forth between a separate mouse-type device and a keyboard or similar interface.

### CROSS-REFERENCE TO RELATED APPLICATIONS

This application claims the benefit of U.S. Provisional Application No. 60/533,299 entitled A USER INTERFACE DEVICE AND METHOD filed on Dec. 30, 2003.

### FIELD OF THE INVENTION

The present invention relates to mouse-type devices that allow users to interface with computers. More specifically, the present invention relates to a device that places a trackball and input buttons in relative proximity to both the hand and computer keyboard via a strap or physical support that precludes the need to move the hand back and forth between a separate mouse-type device and a keyboard or similar interface.

### BACKGROUND OF THE INVENTION

The computer mouse has become one of the most popular means of controlling personal computers. For instance, users depend on a computer mouse in conjunction with a keyboard to efficiently interact with software programs and the Internet through arrow tracking prompts and screen selections.

The success of the computer mouse depends on users' ability to interact with both accuracy and a minimal amount of effort. But because users must constantly switch between a mouse and keyboard (or similar input device), users significantly increase the time it takes to work on the computer and develop muscle strain from the constant shifting of the hand between input devices. An invention that allows users to control mouse-type functions and type on the keyboard (or similar input device) without having to move the hand away can represent an important time-saving measure and provide relief for hand and wrist strain.

To date, the general public has not adopted mouse devices that can be used while a user's hands are in keyboard typing position as a means of increasing computer efficiency. One reason may be that known hand-activated mouse devices used simultaneously with a keyboard have generally elided traditional mouse components familiar to most users and limited the mouse's functionality.

U.S. Pat. No. 4,954,817 discloses a hand-worn mouse-type interface having components worn on a finger or hand with a touch-sensitive area that allows users to control personal computer. To use the '817 interface a user moves a stylus ring (worn on the user's thumb) with a node across a finger palette (worn on the user's index finger) to control a computer screen arrow prompt or digitizing tablet without requiring the user to move his hands away from a computer keyboard. The sideways application of the thumb to the first finger thereby controls the user interaction with a computer or electronic drawing tablet. However, one drawback of the '817 interface is that the user must coordinate the movement of two separate fingers in order to control the device. For some users this can seriously compromise the accuracy of the '817 interface and make it difficult to move a screen prompt precisely. Also, because the finger palette is of a limited size, another drawback of the '817 interface is that the moving of an arrow prompt across a computer screen would require repetitive, successive movements resulting in stress and discomfort on the user's fingers. Further, due to the limited surface area of the finger-worn interface, an additional drawback of the '817 interface is that the interface does not have buttons with comparable functionality to mouse-click buttons, thereby reducing the interface's usefulness as compared to a traditional computer mouse. Although the applied pressure of the stylus ring point onto the finger palette is disclosed as emulating a mouse click button, it appears likely that a user might inadvertently select screen areas while trying to simply move the arrow prompt across the finger palette. In summary, the '817 interface has a number of drawbacks such as being difficult to control, requiring stressful repetitive movements, and having limited functionality when compared to a traditional computer mouse.

U.S. Pat. No. 5,764,164 discloses another conventional device that provides for hand-controlled computer interaction. The '164 device creates electronic command signals to control the movement of objects through hand movement. While the '164 device overcomes some of the shortcomings of the '817 interface by providing finger-activated sensors and buttons on the underside of the hand allowing for specific hand control, the '164 device is not intended for simultaneous use with a traditional computer keyboard or similar interface device. Instead, the '164 system completely covers the underside of the hand rendering any finger manipulation with a keyboard or similar device impossible.

U.S. Pat. No. 5,832,296 discloses an interface that attempts to provide maximum hand flexibility while interfacing with electronic devices. The '296 interface includes a ring-shaped device worn on a user's forefinger with an internal pressure sensor positioned on the outside of the ring. The user can activate the pressure sensor by dragging his thumb across the sensor. This allows the user to potentially move an arrow prompt across a computer screen. The user can also press down applying pressure to the sensor thereby creating an interface action comparable to a mouse-button click. Although the '296 interface to some degree improves the problem of coordinating two separate finger-worn apparatuses of the '817 interface, the '296 interface also suffers from a number of drawbacks. One drawback is that users of the '296 interface are still required to coordinate the movement of the thumb and forefinger. As previously discussed, for some users this coordination may be difficult and may substantially reduce the '296 interface's accuracy in specific tracking operations. Another drawback is that the '296 interface also requires repetitive movements due to the small sensor area provided, potentially causing further stress on the fingers and hand. A further drawback is due to the diminutive size of the '296 interface, the only interfacing comparable to mouse clicking remains in the pressing down of the sensor. Because the sensor relies on finger pressure to determine interaction, users may have difficulty distinguishing between pressing the sensor lightly enough to track an arrow prompt and pressing hard enough to simulate a mouse click.

U.S. Pat. No. 6,201,484 discloses a device worn on the forefinger to wirelessly control computer events remotely without the use of a flat surface. The '484 device suffers from some of the same drawbacks as '817 and '296 interfaces. More particularly, the '484 device requires the user to coordinate the movement of the user's thumb and forefinger. Some users may find this coordination to be difficult and, as a result, the accuracy of arrow prompt tracking on a computer screen may be degraded. Also, the repetitive finger movements required by the '484 device would likely result in repetitive stress on the fingers and hand. While the '484 device does provide slightly more surface area on the device for buttons comparable to traditional mouse click buttons, the buttons on the '484 device appear to be small and the thumb appears to have awkward access to the buttons.

U.S. Pat. No. 6,297,808 discloses a hand controller device that includes a display screen and trackball. In some of the disclosed embodiments the '808 device is worn on a user's finger. However, these embodiments suffer from some of the same drawbacks as '817 and '296 interfaces. More particularly, these embodiments require the user to coordinate the movement of the user's thumb and forefinger. Some users may find this coordination to be difficult and, as a result, the accuracy of arrow prompt tracking on a computer screen may be degraded. In other disclosed embodiments the '808 device is worn on a user's hand. However, these embodiments require a user to grip the '808 device vertically (like a joystick). As a result, the user cannot use the '808 device and simultaneously have access to a keyboard.

The present invention is directed towards overcoming the drawbacks discussed above.

### SUMMARY OF THE INVENTION

A user interface device for use with a computer system, the device including a body shaped to fit into the contour of a user's palm, an attachment device that detachably connects to the body for holding the body in the user's palm, at least one interface button positioned on the body such that the user can manipulate the button by curling a finger towards the user's palm when the body is held in the user's palm, a trackball for controlling a function of the computer system, a trackball support for supporting the track ball such that the user can manipulate the trackball with the user's fingers and thumb, and an arm connecting the trackball support to the body such that the trackball is positioned between the user's thumb and index finger when the body is held in the user's palm.

The user interface device places a trackball and input buttons in relative proximity to both the hand and computer keyboard via a strap or physical support that precludes the need to move the hand back and forth between a separate mouse-type device and a keyboard or similar interface.

### BRIEF DESCRIPTION OF THE DRAWINGS

There are shown in the drawings embodiments which are presently preferred, it being understood, however, that the invention is not so limited to the precise arrangements and instrumentalities shown.

FIG. 1 is a top plan view of the user interface device;

FIG. 2 is a bottom plan view of the user interface device;

FIG. 3 is a top plan view of the user interface device strapped to a user's hand;

FIG. 4 is a bottom plan view of the user interface device strapped to a user's hand;

FIG. 5 is a perspective view illustrating a user using the user interface device in combination with a keyboard;

FIG. 6 is a perspective view illustrating a user using the user interface device in combination with a keyboard;

FIG. 7 is a perspective view of a base platform for the user interface device;

FIG. 8 is a perspective view of the user interface engaged with the base platform;

FIG. 9 is a perspective view illustrating a user operating the user interface device while it is engaged with the platform;

FIG. 10 is a perspective view illustrating a user using the user interface device and platform arrangement in combination with a keyboard;

FIG. 11 is a top plan view of the user interface device strapped to a user's hand via an alternative strap; and

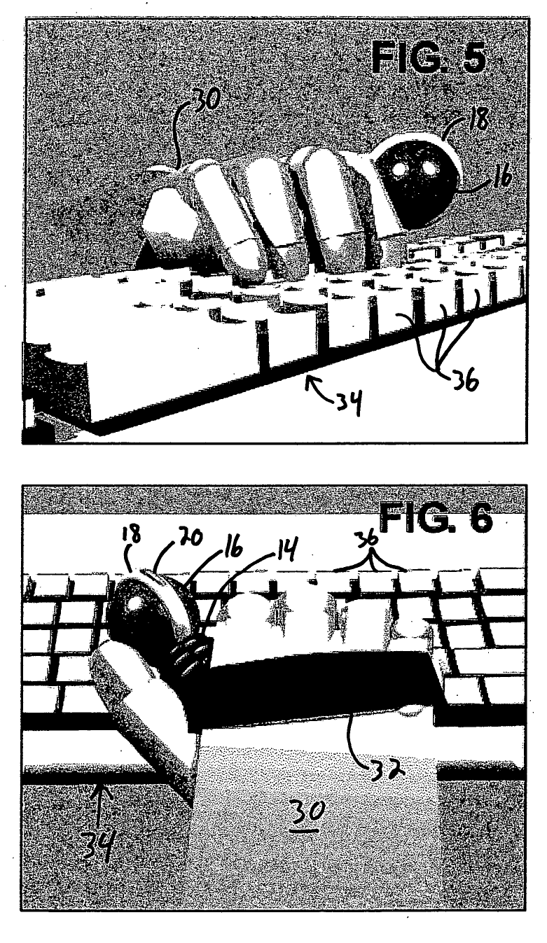

FIG. 4 is a bottom plan view of the user interface device strapped to a user's hand via the alternative strap.

### DETAILED DESCRIPTION OF THE PREFERRED EMBODIMENTS

The characteristics and advantages of the present invention will become more apparent from the following description, given by way of example. It should be noted that the present invention is intended to utilize the hardware and software used by conventional mouse interfaces to interact with computer operating systems. In an effort to provide a concise description of the present invention the description of the underlying hardware and software is not described in this specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

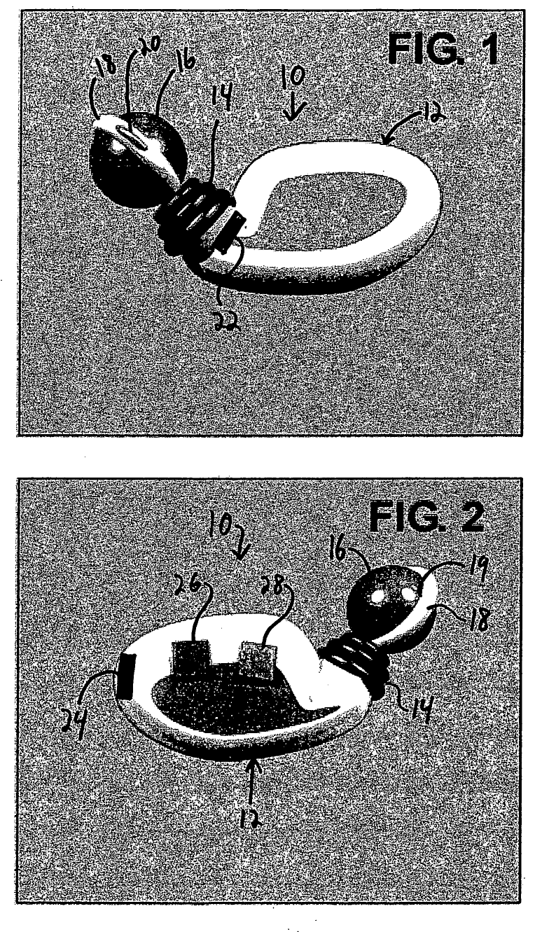

Referring to FIG. 1, the top of the user interface device 10 of the present invention is shown. User interface device 10 includes a body 12, an adjustable arm 14, a trackball 16, a trackball support 18, a scroll sensor 20 and a first strap connector 22.

Body 12 has a rounded oval surface flattened to mirror the contour of the underside of a user's hand when the hand is arranged in keyboard typing position. The top of device 10 fits into the underside of the user's palm comfortably and Body 12 is shallow enough in depth so as not to rub against computer keyboard keys while the user types. Device 10 weighs little so that it provides negligible strain or stress to the hand when used for extended periods of time. It should be noted that body 12 has substantially more surface area than the conventional interface devices discussed above. The increase in surface area allows for interface buttons (discussed below).

Extending out from the side of body 12 is an adjustable arm 14 that allows different users to position trackball 16 relative to their fingers. Adjustable arm 14 can extend or retract, move up and down, bend to the right or left, and swivel in a circular motion to position trackball 16 in comfortable proximity to different hand sizes and user preferences. Adjustable arm 14 may lock into place or, alternatively, may have enough resistance so it does not move without specific user adjustment. Adjustable arm 14 may appear on the left or right hand side of device 10, depending on whether a user prefer to use the right or left hand. Adjustable arm 14 is durable enough to withstand a minor adjustment with each use of device 10 but flexible enough to allow users to easily manipulate and lock adjustable arm 14.

Adjustable arm 14 may be implemented using various assemblies. For example, a flexible steel arm (gooseneck) assembly may be used to adjust the height and position of trackball 16. This steel arm assembly would connect the trackball holder 18 to device 10 and simultaneously secure any sensor or sensor wires needed to translate the motion of trackball 16 to computer input data. This type of gooseneck assembly is manufactured and sold by various companies such as Moffatt Products Inc. of Watertown, S. Dak. Alternatively, adjustable arm 14 may be implemented using a flexible metal tubing assembly similar to the tubing assemblies typically found in adjustable microphone arms with miniature joints that adhere to particular positions. An advantage to using a flexible metal tubing assembly is that the tube itself is hollow thereby allowing any needed sensor wires to run through the tubular length of the arm. This type of flexible metal tubing assembly is manufactured and sold by various companies such as Vermont Flexible Tubing Company of Lyndonville, Vt. Regardless of which implementation approach is used, adjustable arm 14 is covered on the outside by a durable, flexible rubber or plastic that serves to protect the arm from dirt and dust and protect any sensors and sensor components.

Trackball 16 is connected to adjustable arm 14 via trackball support 18. Trackball 16 is configured and handled differently than the trackballs of traditional mouse-type interface devices. Traditionally, trackballs are situated on the underside of the mouse which a user moves to roll the trackball and activate a tracking prompt on a computer screen. Alternatively, some conventional mice situate the trackball on the top of the mouse housing and use gravity to rest the ball on sensors. In operation, the user's fingers roll the trackball itself to activate screen prompts. In the present invention, trackball 16 is held into place by a support 18 connected to one end of adjustable arm 14, leaving the majority of the surface area of the trackball (i.e., the portion of the surface area not covered by support 18) available on either side of support 18 for finger manipulation. Trackball support 18 secures trackball 16 in place, while providing enough mobility so that the trackball 16 can spin uninhibitedly at the touch of a finger or thumb. Trackball 16 should move fluidly enough within trackball support 20 so as not to provide any strain on a user's fingers as the user manipulates trackball 16. Trackball 16 should be light, large, and mobile enough to handle easily, but small enough in size so as not to interfere with computer keyboard keys when typing. Referring briefly to FIG. 4, trackball 16 is positioned by trackball support 18 and adjustable arm 14 to extend outward from body 12 such that trackball 16 is situated between a user's thumb and forefinger. It should be noted that the user may utilize a combination of thumb, forefinger, and middle finger, or simply thumb or forefinger to move the trackball and activate a screen prompt or similar interface device.

An important feature of device 10 is that trackball 16 is made available for hand positioning at the end of adjustable arm 14 supported above a computer keyboard. While most trackballs, however, are situated on the underside of a mouse and pressed down upon with the mouse body or sunk into the top side of a mouse and spun with the fingers, device 10 of the present invention situates trackball 16 outwardly away from body 12 of device 10 and, therefore, must be secured in place using trackball support 18. Trackball support 18 may be implemented in one of several ways. As shown in FIG. 1, a ring-shaped support 18 extends outward from arm 14 and holds trackball 16. Sensors (not shown) positioned within the ring-shaped support 18 and around trackball 16 track the direction that the ball spins and passes the tracking data to a computer-based operating system. In order to secure trackball 16 in support 18, the edges of the inside ring 19 of support 18 may be tapered downward and inwardly toward the trackball 16 to hold it in place. Inner ring 19 may also have small spherical nodules similar to ball bearings built into it that secure the trackball 16 into place, but also allows it to spin freely and easily. Additionally, the outside lip of ring 19 may need small rounded nodules that hold the trackball in the ring-shaped holder 18 without creating friction that would bear down on trackball 16.

An alternative embodiment of trackball support 18 may include additional sensors on the right and left sides of the trackball to effectively track the direction trackball 16 spins. In this embodiment the shape of the ring support may be extended downwards toward the bottom of device 10 to form a shallow depression that trackball 16 will sit in. This depression or bowl shape will provide a sunken area similar to a computer mouse with the trackball sunk into the top of the mouse allowing sensors to be place along the horizontal axes of the depression. It should be noted that it is important that the sides of the depression do not extend too high on either side of trackball 16 as both left and right sides of trackball 16 should remain exposed to allow the thumb and first and second fingers to manipulate trackball 16.

Scroll sensor 20 is a toggle switch positioned on the top of trackball support 18. By lifting the thumb from a keyboard to the top of trackball support 18, a user may manipulate, with a minimal amount of duress, scroll sensor 20 in a similar fashion to a traditional scroll wheel provided on a conventional computer mouse.

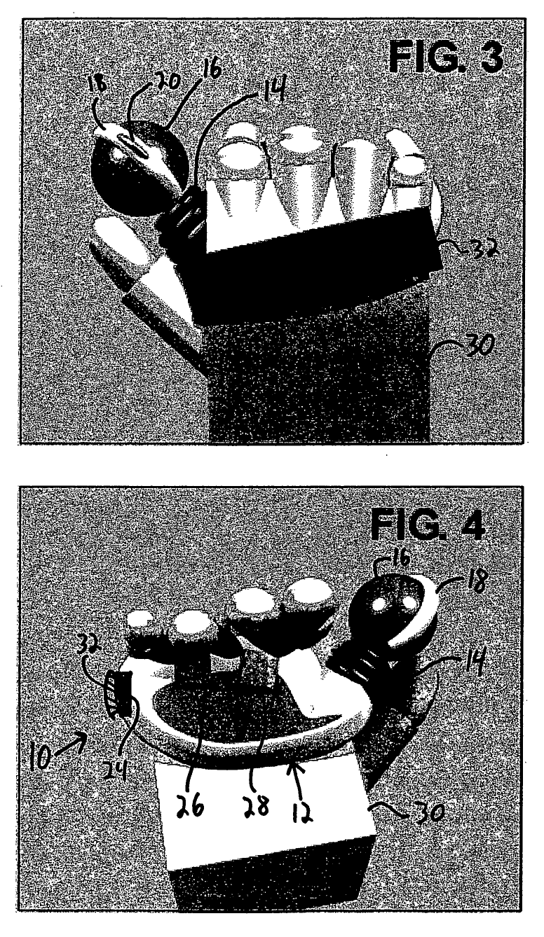

Referring now to FIG. 2, the bottom of user interface device 10 is shown. As shown, user interface device 10 also includes a second strap connector 24 and two interface buttons 26 and 28. Interface buttons 26 and 28 may be utilized for the conventional applications provided by left and right mouse-click buttons on a conventional computer mouse or touch pad. Buttons 26 and 28 are positioned on the front or underside contour of the device so a that user can easily and quickly manipulate buttons 26 and 28 by curling the first, index, and ring fingers backwards from a typing position toward body 12 to engage buttons 26 and 28 while the user is typing. Buttons 26 and 28 may also coordinate with macros of particular software or operating systems to provide further programmatic functionality as defined by the user.

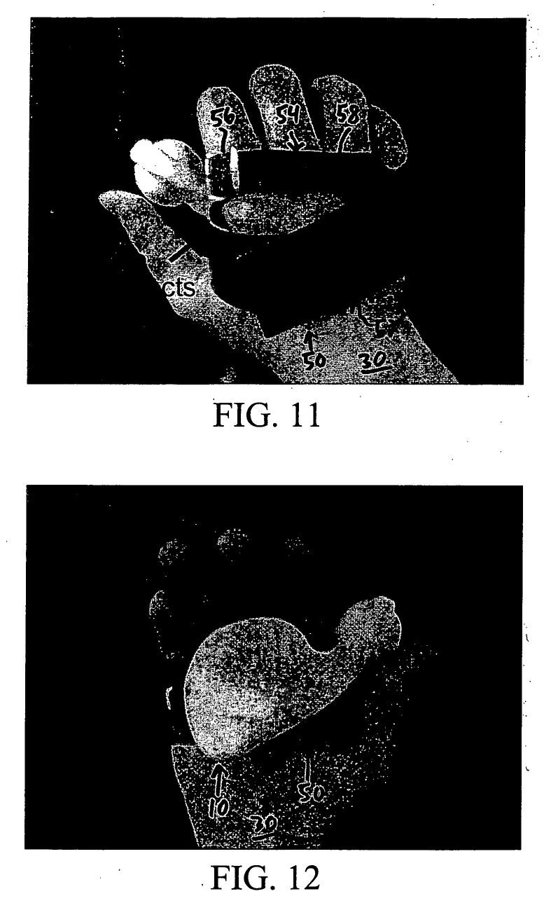

Referring now to FIGS. 3 and 4, user interface device 10 attached to the underside of a user's hand via a strap 32 is shown. Strap 32 attaches to device 10 via strap connectors 22 and 24 (shown in FIGS. 1 and 2). Strap 32 may be constructed of leather, nylon, Lycra, or another durable and breathable fabric that allows the device to connect comfortably to the hand. Strap 32 may be a single strap (as shown) that is similar to those used with hand-held electronic devices such as cameras or video cameras. Alternatively, the strap may be a custom strap system 50 designed specifically for device 10, as shown in FIGS. 11 and 12. Strap system 50 includes a main strap 52 that extends around the base of the hand and a smaller adjustable strap 54 that extends off of main strap 52. Adjustable strap 54 fits over the user's fingers just above the knuckles. Strap system 50 connects to strap connectors 22 and 24 positioned on the top left and underside right side of device 10 (as shown in FIGS. 1 and 2). It should be noted that strap system 50 allows a user's fingers and knuckles to move freely in order to interact with device 10 and keyboard simultaneously.

Adjustable strap 54 is adjustable to fit different sizes of hands and also position the device comfortably relative to a user's hand and fingers. The adjustability of strap 54 can be achieved in several different ways. As shown in FIG. 11, a buckle 56 and strap hole 58 arrangement may be used to adjust the size of strap 54 and secure device 10 into place. In operation a user would pull strap 54 through buckle 56 and insert the buckle tongue into one of a plurality of strap holes 58 when the desired strap tightness is achieved.

An alternative adhesion system (not shown) that may be used to secure strap 54 to the user's hand uses male and female strips, sold under the Velcro trademark, attached to strap 54 and used in conjunction with a buckle. This type of system is found in sandals where the user pulls a strap through a buckle and folds it back over securing the female Velcro strip to the male Velcro strip. In a similar manner, the user would be able to pull strap 54 through a buckle to determine the tightness to the hand and then, using the strap as leverage, pull the strap back over on top of itself in the other direction and connect the strap into place via the female and male Velcro strips.

Another alternative strap 54 dispenses of using a buckle or moving parts altogether, by using a stretchable fabric such as the fabric sold under the Lycra trademark to secure the smaller strap to the hand. This approach has been proven effective in products such as diving watches and gloves. The advantages of using Lycra fabric as an adjustable strap are that the strap would be lightweight, contain no separate parts, and fit comfortably around the hand. The fabric, however, would need to be durable in order to effectively hold the weight of the device close to the hand and not become stretched out over time. Therefore, if using Lycra fabric, the material may need to be reinforced with padding or several layers of Lycra fabric to create a durable thickness.

It should be noted that strap 32 (shown in FIGS. 3 and 4) and strap 50 (shown in FIGS. 11 and 12) are removable to allow device 10 to be alternatively used with a supporting platform instead of a strap, as discussed in further detail below. In order for strap 32 or 50 to be removed from device 10 so device 10 may be used with a base platform, strap 32 or 50 must have a connection system to easily attach to or detach from device 10. As discussed above, strap 32 or 50 attach connect to strap connectors 22 and 24 positioned on the top left and underside right side of device 10 (as shown in FIGS. 1 and 2). The connection system for securing strap 32 or 50 to device 10 may take one of several forms. A first connection system includes a small metal or plastic tongue (similar to a seatbelt) attached to both ends of strap 32 or 50 to engage with associated matching slots provided on device 10. In operation, users would take the tongues protruding off of either end of strap 32 or 50 and secure them into slots on either side of device 10. To detach strap 32 or 50, the user could click an unlock button on the top of the tongue that would release the tongue from the device slot. This type of connection system is commonly found in luggage. An alternative connection system includes attaching a plastic end with teeth on either end of strap 32 or 50. The teeth would lock into grooves built into body 12 of device 10. This type of connection system is commonly used to connect the straps of cameras, backpacks, camping gear, and other durable strap systems. Another alternative connection system may be a button system similar to that found on clothing buttons or button attached suspenders. In this connection system, a hole-like enclosure connected to either end of strap 32 or 50 could wrap around a button or node on body 12 of device 10 thereby securing strap 32 or 50 to device 10.

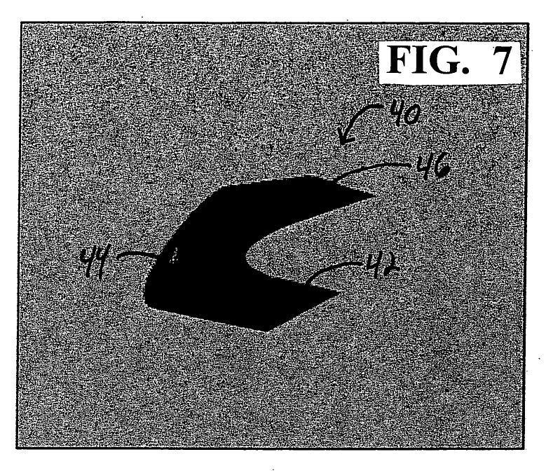

Referring now to FIGS. 5 and 6, the use of device 10 in combination with a computer keyboard 34 is illustrated. A user can access the keys 36 of keyboard 34 and control mouse functions without moving the user's hand and arm back and forth between separate devices. Instead the user switches between keyboard 34 and device 10 by easily moving the user's fingers from keyboard keys 36 to interface buttons 26 and 28 and trackball 16.

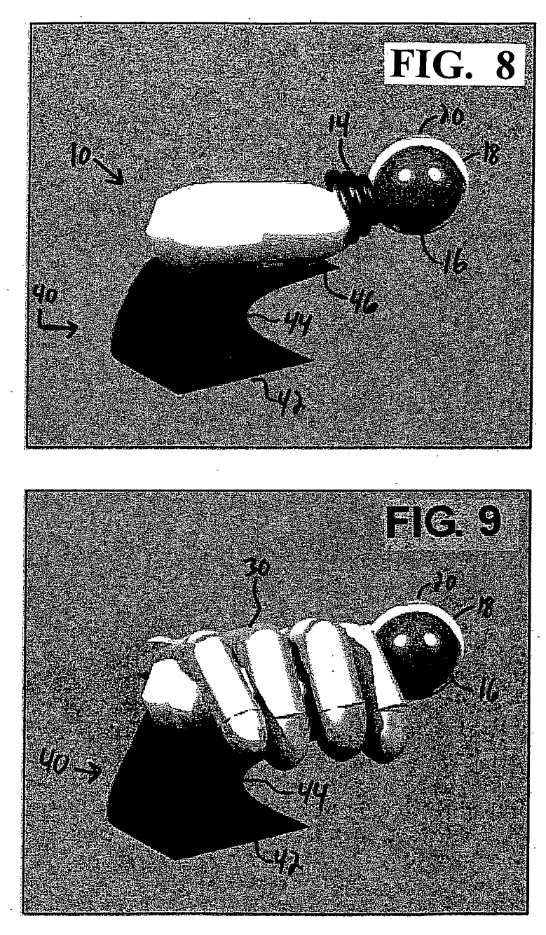

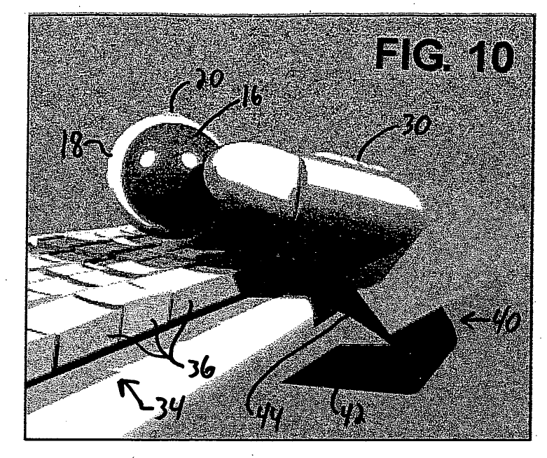

Referring now to FIGS. 7-10, when the user is not using strap 32 or 50, device 10 may be mounted onto a platform 40 that suspends device 10 above keyboard 34 allowing the user's hands and fingers to interact seamlessly between keyboard 34 and device 10 without requiring the user to move his hands away from keyboard 34. In order for platform 40 to be effective, it needs to be adjustable to allow the user to position the device relative to different kinds of keyboards and personal preferences. Platform 40 includes a flat, relatively heavy base member 42 made of solid plastic or similar durable material that slips underneath keyboard 34 easily and provides a solid foundation to root platform 40 to the table. Out of body member 42 extends a curved moveable neck member 44 that extends over keyboard 34 much like the arm on a desk lamp and similar to trackball arm 14 of device 10, except that the movement of neck member 44 is limited to a curved up and down motion. A head member 46 secures device 10 onto neck member 44 and moves independently of neck member 44 via joints in the base of head member 46 that connect head member 46 to neck member 44. In this way, users can adjust the curve of neck member 44 without affecting the horizontal axis or tilt of device 10 on head member 46, similar to the way a microphone can keep the same horizontal direction using a base screw in a microphone holder, even though the gooseneck part of the microphone stand may be curved in different up and down directions. Platform 40 should be heavy enough to root platform 40 and device 10 solidly to the table, but thin enough in width and girth so as not to restrict the user from typing on computer keyboard 34. Neck member 44 must be flexible in order for the user to adjust it, but provide enough resistance so that users don't accidentally press lightly on device 10 and inadvertently press it into keyboard 34. A button-based locking mechanism may be used in platform 40 to lock moveable neck member 44 into place, effectively freezing platform 40 exactly where the user wishes.

In order to secure device 10 to platform 40, head member 46 of platform 40 includes a locking system that interacts with the bottom of device 10. Head member 46 of platform 40 is contoured to match the underside of device 10 so device 10 rests snugly on head member 46 of platform 40. Device 10 can be secured to head member 46 through several means. Head member 46, for instance, may have small nodes that connect and lock into two small depressions on the underside of device 10 in much the same way that an electrical plug fits into a socket or a computer mouse or phone fits on a battery charger. Device 10 would lock into place once inserted and a button-based release can be pressed by the user to release the node from device 10 thereby setting device 10 free. An alternative is having a plastic clasp built into head member 46 whereby the user could tilt device 10 under the clasp and then level device 10 to lock device 10 into place. Similarly, tilting and lifting device 10 would remove device 10 from head member 46 of platform 40. This approach is often seen on battery compartments in which a removable door is tilted to connect to the body of a device and then pressed closed locking into place.

The invention disclosed herein can be embodied in other specific forms without departing from the spirit or essential attributes thereof. Accordingly, reference should be made to the following claims, rather than to the foregoing specification, as indicating the scope of the invention.

1. A user interface device for use with a computer system, said device comprising:
a body shaped to fit into the contour of a user's palm;
an attachment device that detachably connects to said body for holding said body in said user's palm;
at least one interface button positioned on said body such that said user can manipulate said button by curling a finger towards said user's palm when said body is held in said user's palm;
a trackball for controlling a function of the computer system;
a trackball support for supporting said track ball such that said user can manipulate said trackball with said user's fingers and thumb; and
an arm connecting said trackball support to said body such that said trackball is positioned between said user's thumb and index finger when said body is held in said user's palm.

2. The user interface device of claim 1, wherein said arm is adjustable such that said user can move said trackball to position desired by said user.

3. The user interface of claim 1, wherein said at least one interface button is two interface buttons and said user interface devices interacts with said computer system such that said two interface buttons provide right and left computer mouse-like functions when manipulated by said user.

4. The user interface device of claim 1, wherein said at least one user interface button is position on a bottom of said body.

5. The user interface device of claim 1, wherein said track ball support is ring-shaped such that said user can access said trackball with a thumb on one side of said ring and with a finger on the other side of said ring when said body is held in said user's palm.

6. The user interface device of claim 1, further comprising a scroll sensor positioned on said trackball support such that said user can control a scrolling function of said computer system by manipulating said scroll sensor with at least one of a finger and a thumb.

7. The user interface device of claim 1, wherein said attachment device holds said body in said user's palm such that said user can manipulate said trackball and said at least one interface button of said user interface device and a keyboard of said computer system by moving said user's fingers.

8. The user interface of claim 1, wherein said attachment device is a strap that detachably connects to said body, said strap wrapping around a back of said user's hand to hold said body in said user's palm.

9. The user interface device of claim 1, wherein said attachment device is a strap system that detachably connects to said body and wraps around a back of said user's hand to hold said body in said user's palm, said strap system including a first strap that wraps around a lower portion of said back of said user's hand and a second strap that wraps around an upper portion of said back of said user's hand.

10. The user interface device of claim 9, wherein said second strap wraps around said upper portion of said back of said user's hand above said user's knuckles.

11. The user interface device of claim 10, wherein said second strap is adjustable by said user.

12. The user interface device of claim 1, wherein said attachment device is a platform having a base member that said user can position underneath a keyboard of said computer system, a head member that detachably connects to the bottom of said body of said user interface device, and a neck member that connects said base member to said head member such that said head member is positioned over said keyboard.

13. The user interface device of claim 12, wherein a height of said neck member is adjustable by said user.

14. The user interface device of claim 12, wherein a tilt of said head member is adjustable by said user.
